(19) United States
(12) Patent Application Publication
(10) Pub. No.: US 2001/0037852 A1
(43) Pub. Date: Nov. 8, 2001

(54) Process and device for punching thin films

(76) Inventor: Gerhard Klemm, Oerlinghausen (DE)

Correspondence Address: MCGLEW & TUTTLE, PC, SCARBOROUGH STATION, SCARBOROUGH, NY, 10510, US

(21) Appl. No.: 09/828,329

(22) Filed: Apr. 5, 2001

(30) Foreign Application Priority Data
Apr. 5, 2000 (DE) 100 16 811.6

(51) Int. Cl. B32B 31/00

(52) U.S. Cl. 156/253; 156/512

(57) ABSTRACT

A process is provided for punching a thin film (2), preferably one formed of a plastic, as well as a punching device for carrying out the process. In the process, the thin film (2) is fed by a feed device (1) to a downstream punching station (4) and transferred to a downstream processing station (13) after the punching operation. The thin film (2) to be punched is joined with a self-sticking reinforcing film (9) on the side facing away from the punching tool before being fed to the punching station (4).

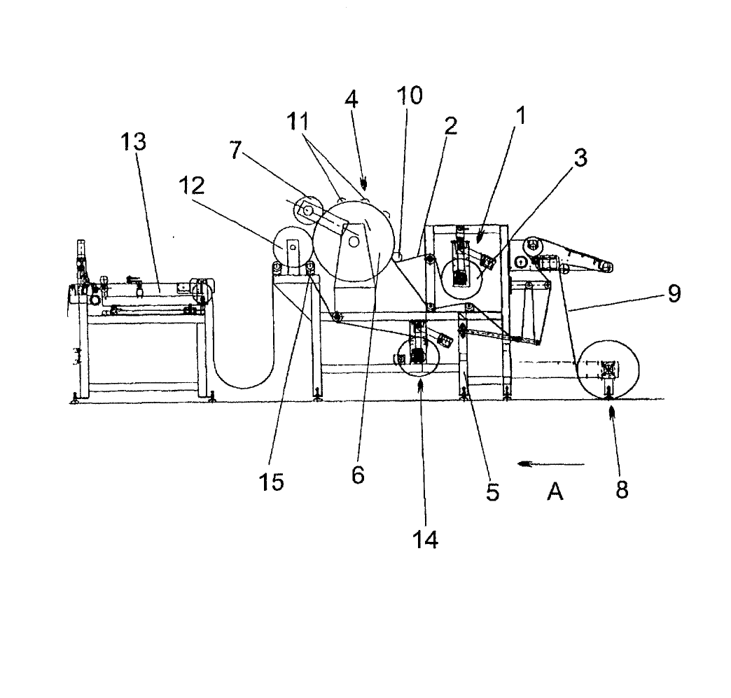

### FIELD OF THE INVENTION

The present invention pertains to a process for punching thin plastic films in which the film to be punched is fed by a feed device to a downstream punching station and is transferred to a downstream processing station after the punching operation.

### BACKGROUND OF THE INVENTION

The punching of thin plastic films represents a special problem in the state of the art because the handling of such films is very difficult, especially during the punching operation. As a result of this, the finished films have great variations in terms of dimensional accuracy, which considerably limits their further processing.

### SUMMARY AND OBJECTS OF THE INVENTION

The object of the present invention is therefore to improve a process for punching thin and very thin films to the extent that the manufacture of the punched parts within the films can be carried out substantially more accurately and that the handling during the punching operation can be facilitated and inexpensive manufacture can be guaranteed. In addition, another object of the present invention is to provide a device which is able to also punch very thin films with high dimensional accuracy.

The object is accomplished according to the present invention by the films being joined with a self-sticking reinforcing film on the side facing away from the punching side before they are fed to the punching station.

Moreover, special embodiments of the process according to the present invention provide for severing the thin film over its total thickness at the punching station, while the reinforcing film remains intact in at least a partial area of its total thickness and for the thin film and the reinforcing film being again separated after the punching operation, while the punched-out partial areas of the thin film continue to adhere to the reinforcing film.

Due to the process steps according to the present invention according to which the components punched out of the thin film remain on the bonding film after the punching station and after separation of the thin film and the bonding film, a special disposal of the punch-out waste parts becomes unnecessary and the hitherto usual suction or blow-off devices thus become superfluous.

A paper film provided with an adhesive layer has proved to be particularly suitable for use as a reinforcing film, because it is commercially available at favorable prices in various variants depending on the required adhesive power of the adhesive layer.

The punching device for carrying out the above-described process according to the present invention is characterized in that it has an unwinding device for the reinforcing film and that a pressing roller for bringing together the reinforcing film and the thin film to be punched is arranged in front of the punching station. Due to the design of the punching station, it is guaranteed for the production process that the reinforcing film and the thin film are bonded to one another by the adhesive layer without folds during the punching operation.

Corresponding to a special design embodiment of the device according to the present invention, a vacuum draw roller with a deflecting roller for separating the reinforcing film and the thin film may be arranged after the punching station, so that the reinforcing film and the thin film are again separated from one another after the end of the punching operation, so that the punched thin film can be fed to the downstream work stations without problems, whereas the reinforcing film can be sent for disposal.

Another advantageous embodiment of the punching device additionally makes provisions for a winding device for the reinforcing film, on which the reinforcing film is wound up together with the punching wastes remaining on the film, being arranged after the vacuum draw roller and the deflecting roller for separating the reinforcing film and the punched thin film in the working direction of the punching device.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

The only FIGURE is a side view of a punching device according to the present invention.

### DESCRIPTION OF THE PREFERRED EMBODIMENT

Referring to the drawings in particular, the punching device comprises a mounting frame 5, which accommodates the various assembly units of the punching device. The work sequence of the punching operation takes place from right to left in the FIGURE corresponding to arrow A.

The essential assembly units of the punching device are the punching device 4 comprising a rotating main cylinder 6 and a magnetic or engraved punching cylinder 7. Viewed in the working direction, a feed device 1, which is designed as an unwinding station and ensures that the thin film 2 to be punched, which preferably consists of a plastic, can be fed to the main cylinder 6 of the punching station from a supply roll 3, is located in front of the punching station 4.

Moreover, an unwinding device 8 for a reinforcing film 9 provided with an adhesive layer is located at the beginning of the punching station, connected to the frame 5. The reinforcing film 9 preferably consists of an adhesive-coated paper or a plastic film of a thickness substantially greater than that of the thin film to be punched and is likewise fed to the main cylinder 6 via a plurality of deflecting rollers. A pressing or laminating roller 10, which is arranged such that a narrow gap is formed between it and the main cylinder 6, through which gap both the thin film 2 and the reinforcing film 9 are led, is located at the main cylinder 6 on the outer circumference. The pressing roller 10 is used to press the thin film 2 onto the reinforcing film 9, the reinforcing film 9 being arranged such that the bonding film arranged on it faces the underside of the thin film 2.

The thin film and the reinforcing film, which are bonded to one another by the adhesive layer, are pulled over the circumference of the main cylinder 6, and a plurality of reading mark scanning units 11 are arranged on the circumference of the main cylinder 6. After the reading marks 11 have passed through, the necessary openings are prepared in the film 2 by the magnetic or engraved punching cylinder 7. The depth of punching is set such that the total thickness of the thin film 2 is punched through, but at least a partial area of the subjacent reinforcing film 9 remains intact. The magnetic punching cylinder 7 is preferably joined on the circumference of the main cylinder 6 by a vacuum draw roller and a deflecting roller 15. This roller unit has the task of again separating the thin film 2 and the reinforcing film 9 from one another. The film 2 is subsequently fed to a checking desk 13 or another work station, e.g., for lamination, whereas the reinforcing film 9 is removed in the downward direction together with the punched-out wastes of the thin film which have continued to adhere to the adhesive layer of the reinforcing film 9 and is collected on a winding device 14.

Due to the fact that the punched-out waste parts of the punched thin film 2 remain on the reinforcing film, usually necessary disposal means, e.g., suction units for the punching remnants, become unnecessary.

While specific embodiments of the invention have been shown and described in detail to illustrate the application of the principles of the invention, it will be understood that the invention may be embodied otherwise without departing from such principles.

What is claimed is:

1. A process for punching a thin film consisting of a plastic, the process comprising:
feeding a thin film to be punched, using a feed device, to a downstream punching station;
transferring the thin film to be punched to a downstream processing station after a punching operation;
joining the thin film with a self-sticking reinforcing film on a side facing away from the punching tool prior to feeding the thin film to the punching station.

2. A process in accordance with claim 1, wherein an adhesive-coated paper film is used as the reinforcing film.

3. A process in accordance with claim 1, wherein said thin film is severed over a total thickness of said thin film at the punching station and said reinforcing film remains intact over at least a partial area of its total thickness.

4. A process in accordance with claim 1, wherein the punched thin film and the reinforcing film are separated after the punching operation with the punched-out partial areas of the punched film continuing to adhere to the reinforcing film.

5. A process for punching a thin film, the process comprising:
feeding a thin film using a feed device to a downstream punching station;
joining the thin film with a self-sticking reinforcing film on a side facing away from the punching tool prior to feeding the thin film to the punching station; and
transferring the thin film to be punched to a downstream processing station after a punching operation at said punching station.

6. A process in accordance with claim 5, wherein an adhesive-coated paper film is used as the reinforcing film.

7. A process in accordance with claim 6, wherein said thin film is severed over a total thickness of said thin film at the punching station and said reinforcing film remains intact over at least a partial area of its total thickness.

8. A process in accordance with claim 7, wherein the punched thin film and the8 reinforcing film are separated after the punching operation with the punched-out partial areas of the punched film continuing to adhere to the reinforcing film.

9. A punching device, comprising:
a feeding device for feeding a thin film;
an unwinding device for unwinding a reinforcing film;
a laminating roller for bringing together the reinforcing film and the thin film to be punched; and
a punching station, said laminating roller being positioned in front of and upstream of said punching station.

10. A punching device in accordance with claim 9, further comprising:
a vacuum draw roller for separating the reinforcing film from the thin film, said vacuum draw roller being arranged downstream of said punching station.

11. A punching device in accordance with claim 10, further comprising:
a winding device for the reinforcing film, said winding device being arranged downstream of the vacuum draw roller with respect to a working direction.
